(19) United States
(12) Patent Application Publication
(10) Pub. No.: US 2003/0056434 A1
(43) Pub. Date: Mar. 27, 2003

(54) Seedling protector

(76) Inventor: Robert F.J. Gleadall, Edmonton (CA)

Correspondence Address: THOMAS E. MALYSZKO, SUITE 1500, 250 - 6 AVENUE, S.W., CALGARY, T2P 3H7, CA

(21) Appl. No.: 10/200,760

(22) Filed: Jul. 24, 2002

(30) Foreign Application Priority Data
Jul. 24, 2001 (CA) 2,353,711

(51) Int. Cl. A01G 13/02

(52) U.S. Cl. 47/32.4

(57) ABSTRACT

A protector for seedlings or small trees is provided having top and bottom protective covers that may be used individually or may be snap locked together in a plural format. Each cover is made of a sheet of moulded pliable polymer material, capable of being folded along its center to form a living hinge. A channel-like portion to each side of the hinge is formed by a plurality of stacked shell-form bodies, each with a poly hourglass shape. A bottom end has a hole, typically of a two inch diameter, for surrounding the seedling. The top protective cover formed by the channel-like portions consists of a roof member that is adapted to collect water internally in the form of condensation and externally in the form of rain, and to disperse the water onto the plant. The bottom protective cover is open at its top end and has one male snap on each sidewall for mating with respective female slots on the top protective cover when connecting both covers. Spine members, one on each side of the channel-like portion, add strength and rigidity to the protective cover when it is open or folded in a closed position. These spine members also form part of a locking mechanism wherein single or dual wooden stakes or metal rods are weaved through locking straps on the spine members to create a very strong and superior locking system to prevent small rodents and larger animals like deer from reaching the protected seedling in the cavity area.

### FIELD OF INVENTION

The present invention relates to a protective device for seedlings and small trees.

### BACKGROUND OF THE INVENTION

Seedlings and small trees are susceptible to damage from rodents and larger animals such as deer. It is, therefore, common practice to cover seedlings with tubular shaped devices to try to protect them. One such popular tube allows for one or two wooden or metal stakes to be bound thereto with plastic ties. These plastic ties are prone to failure, rendering the tubes ineffective. Such tubes are also very bulky and expensive to ship because of their inability to compress in transit. Poor access into the tubes can also cause branches to break off when the tubes are removed from grown seedlings. Further, the prior tube devices do not offer a means of self watering the seedlings when planted in arid climates.

### SUMMARY OF THE INVENTION

What is therefore desired is an improved form of protective cover for seedlings and small trees.

This invention comprises of at least two rectangular sheets of plastic which make up top and bottom covers of this protective device. These sheets are creased and folded in the center creating a living hinge when polyethylene or some other suitable polymer material is used.

In a preferred embodiment, each cover of the device consists of two inverted shell form bodies separated by one living hinge, which when folded creates the necessary cavity that will protect the seedling, and a spine that will increase its rigidity. Adjacent to each of the two inverted shells are two sets of four locking straps and corresponding holes mounted on the spine that will allow for the option of inserting either wooden stakes or metal rods, or the like. The large locking straps will also be used to snap together and lock the top cover to the bottom cover of the device and also allows for an unlimited height to be achieved when additional covers are added

The top protective section of the present device consists of a concave portion and a small centered hole, and a larger perforated circular segment with an attached ring at the top of the inverted shell form bodies. This will allow for water to enter the protected seedling area and allow condensation that forms at the inner part at the top of the concave section to drip onto the seedling in a self watering fashion. A four inch diameter hole is located at the bottom of inverted shell form bodies that will allow the seedling to grow into the top section of the protective device. The ring and perforated circular segment may be permanently removed allowing for a large opening in its place.

The bottom protective section of the present device consists of a large hole with a snap fit element at the top of the inverted shell form bodies and a large hole at the bottom. This snap fitting element will allow for a convenient and inexpensive way to join the top and the bottom protective covers for the seedlings. A four inch diameter hole is located at the top of the inverted shell form bodies that allows the seedling to grow into the top cover of the protective device and a smaller hole at the bottom to keep the rodents from entering.

A problem with using prior art tube like devices, as described earlier, is that post production costs are increased when one includes the assembly of plastic ties which are required. In addition, such ties can break very easily, rendering the prior art protective devices unusable. More beneficial results are obtained with the present invention when four very strong weave locks are formed into the one piece of plastic that makes up the top cover, and into the one piece that makes up the bottom cover.

Another problem with using the prior art tube like devices, as described earlier, is that gaining access to the seedling, when necessary, is very difficult without damaging the plant. More beneficial results are obtained with the present invention when a “living hinge” (as referred to in the Plastics Industry) is provided by the present invention. A living hinge is created when a thin crease in a flat piece of extremely pliable plastic can be bent back and forth like a door without failure. This will allow the present protective device to be opened and closed as needed for maintenance on the seedlings.

Another problem with the prior art tube like devices, as described earlier, is that the tube shape takes up a great deal of space when shipping the protective device to market, resulting in needless additional shipping costs. In addition, most of the polymer materials that are used for such devices are subject to creep. Creep occurs when a given load stresses the polymer beyond its ability to go back to its original shape, resulting in permanent damage to the plastic device. In an effort to save money by shipping as many parts at one time, many of these products get damaged in transit. More beneficial results are obtained with the present invention due to the ability to stack the present devices more then ten pieces per inch, in the flat position, for shipping. This results in a dramatic reduction in shipping costs and avoids damage due to creep.

Yet another problem with the prior art tube like devices, as described earlier, is that such tubes may be subject to major deflections under vertical or horizontal loads, causing damage to the seedlings within the tubes. More beneficial results are obtained with the present invention by employing a spherical hour-glass shape in the geometry of inverted shell form bodies, producing a very high strength to weight ratio of the polymer being used. This produces a much stronger part for a less expensive price. In addition, cross ventilation is available in the seedling area when venting holes are added to the inverted shell form bodies.

Still another problem with the prior art tube like devices, as described earlier, is that the top of the tube is wide open, allowing moisture to evaporate into the atmosphere. More beneficial results are obtained with the present invention when the top of the protective device is closed off in a concave manner, with a small hole in the center. This allows moisture to condense at the inner top of the protective device, watering the plant in a self-watering fashion. The small hole will also allow rain to enter into the seedling area.

Another problem with using the prior art tube like devices, as described earlier, is that the tube is limited to the size that it has been cut to. More beneficial results are obtained with the present invention from a snap fit mechanism incorporated into the protective device, allowing the available size for sapling protection to range from two feet to more then ten feet in height.

Yet another problem with using the prior art tube like devices, as described earlier, is that the function of the tube is limited. More beneficial results are obtained with the present invention because one piece of plastic is versatile enough to allow for numerous functions at one time. The one piece of plastic may be folded in half to create a strong cavity for the seedling and allow for instant access. This cavity may also have a poly hour-glass shape of the inverted shell form bodies allowing for better cross ventilation and greater strength while using less material. More benefits may come about when this folded section instantly doubles the material thickness in the spine area were the greater strength is needed for support. When this one piece of plastic is folded in half more benefits become apparent when a very strong and reliable weave locking system provides security to the seedling or small tree. Even greater benefits become apparent when this same piece of plastic can be formed to make this a self watering device and a device that can be snap locked to other like pieces to enable varying heights for different size seedlings and small trees.

### BRIEF DESCRIPTION OF THE DRAWINGS

These and other features of the invention will become more apparent from the following description in which reference is made to the appended drawings, wherein:

FIG. 1 is a perspective view of a top section of a seedling and tree protector in its open state, according to a preferred embodiment of the present invention.

FIG. 2 is a perspective view of a bottom section of the preferred embodiment of the seedling and tree protector in its open state.

FIG. 3 is a perspective view of the top and bottom sections being joined together by means of snap fitting.

FIG. 4 is a perspective view of the top and bottom sections after being joined and just before being wrapped around a seedling.

FIG. 5 is a perspective view of a part of the joined top section as wooden stakes are being installed.

FIG. 6 is a perspective view of a part of the joined top section as metal rods are being installed.

FIG. 7 is a partially broken away perspective view, from above, of the joined top section showing the cross-ventilation at the top of the present device.

FIG. 8 is a partially broken away perspective view, from below, of the joined top section showing the internal self-water process.

FIG. 9 is a perspective view, from above, of the joined top section showing external watering from the top.

FIG. 10 is a perspective view of the joined top sections illustrating the stackability thereof.

FIG. 11 is a perspective view of the joined top and bottom sections to illustrate the present invention's protective properties from animals after installation on a seedling.

### DETAILED DESCRIPTION OF THE PREFERRED EMBODIMENT

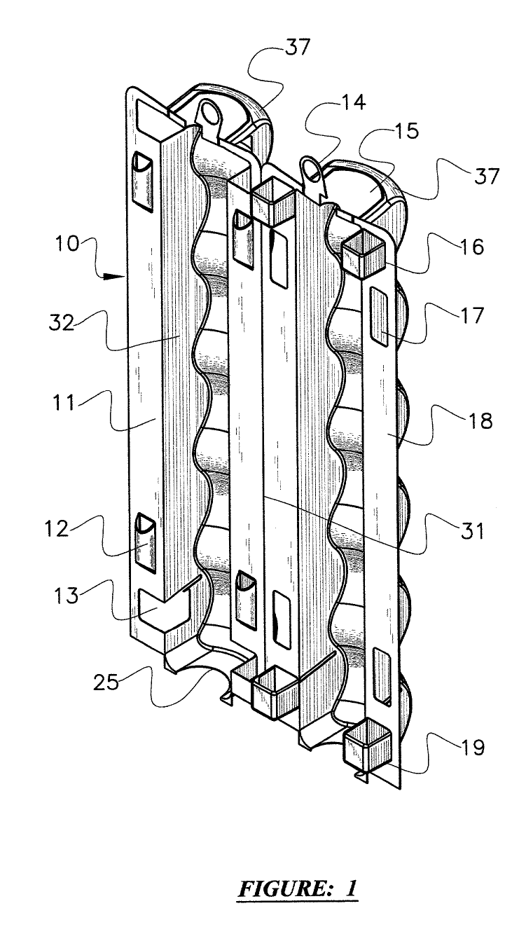

A preferred embodiment of a protective device for seedlings and small trees is generally identified by reference numerals 10 and 20, and will be described with reference to FIGS. 1 through 11.

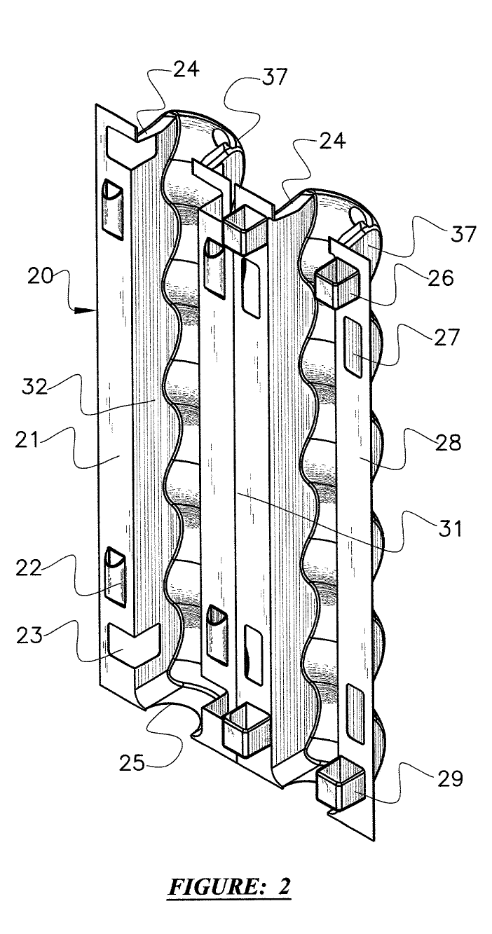

Reference is first made to FIGS. 1 and 2 which show a top cover 10 and a bottom cover 20 of the invention for protecting seedlings and small trees, each formed from a polymer sheet. Each cover 10, 20 is formed of two sections (a left and right section as viewed in the figures) connected by a living hinge 31, which is created when the covers are folded in the center along a longitudinal centerline. Each section on each side of the living hinge 31 has a sinusoidal, channel-like formation defined by a series of interconnected bodies 37, namely dual inverted channel-like shell-form bodies with a poly hourglass shape. Each of these shell-form bodies 37 include a pair of spaced planar sidewalls 32, and a bottom end with a hole 25, preferably about two inches (approx. 50 mm) in diameter. Referring specifically to FIG. 1, a roof portion 15 of the top cover 10 has a spherical concave shape and a circular perforated section that can be removed by pulling on a finger tab 14. Referring specifically to FIG. 2, the upper end of the bottom cover 20 is open, with the exception of the snap lock tabs 24.

Referring again to FIGS. 1 and 2, the top cover 10 has a left spine 11 extending perpendicularly from each sidewall 32 of the left section, and a right spine 18 extending perpendicularly from each sidewall 32 of the right section. Likewise, the bottom cover 20 has a left spine 21 extending perpendicularly from each sidewall 32 of the left section, and a right spine 28 extending perpendicularly from each sidewall 32 of the right section. The right spine 18 of the top cover has two pairs of locking straps 16 and 19, and likewise the right spine 28 of the bottom cover has two pairs of locking straps 26 and 29. The “size”, or perimeter, of straps 16 and 26 is smaller than that of straps 19 and 29, so that the former may mate with the latter, as set out later. Corresponding rectangular shaped holes 13 and 23 are located on the left spines 11 and 21, respectively, one in each corner as shown, so that the locking straps 16 and 26 will pass through in order to be in a locked position when the sections of the covers are joined. Smaller cylindrical locking straps 12 and 22 located on the left spine 11 and 21, respectively, just above and below the rectangular holes 13 and 23, as shown. The corresponding holes 17 and 27 are located on the right spine 18 and 28, respectively, just above and below the rectangular locking straps 16, 26, 19 and 29. The top cover 10 is used by itself for protecting small seedlings and trees, whereas a combination of the top and bottom covers 10 and 20 are used to protect larger seedlings and trees.

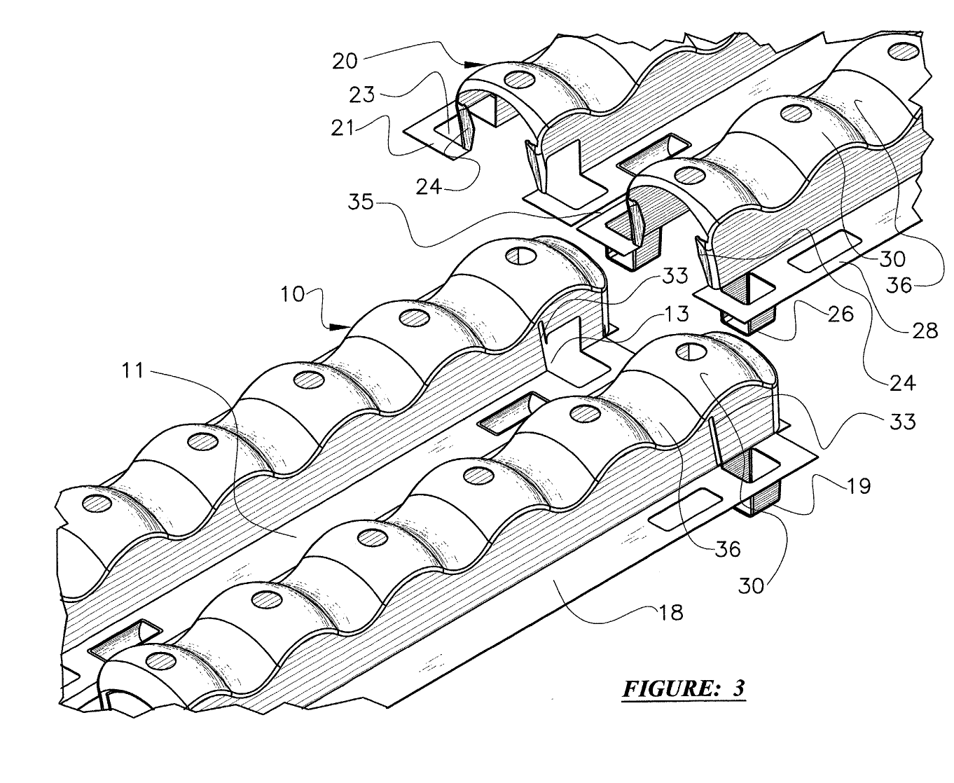

Reference is made to FIG. 3 which shows the top 10 and the bottom 20 covers being joined to make up one unit. The joining is done by placing the bottom cover 20 over the top cover 10 at the point where the outer part of the rectangular locking strap 26 can be placed into the void form of the rectangular locking strap 19. At this time the left spine 11 and 21 and the right spine 18 and 28, the rectangular holes 13 and 23, and the maximum diameter portion 30 and the minimum diameter portion 36 of the poly hour-glass shape should match up with each other. The two parts 10, 20 are then snap fitted as a protruding male lip 24 is mated inside a female slot 33 to lock the two covers together.

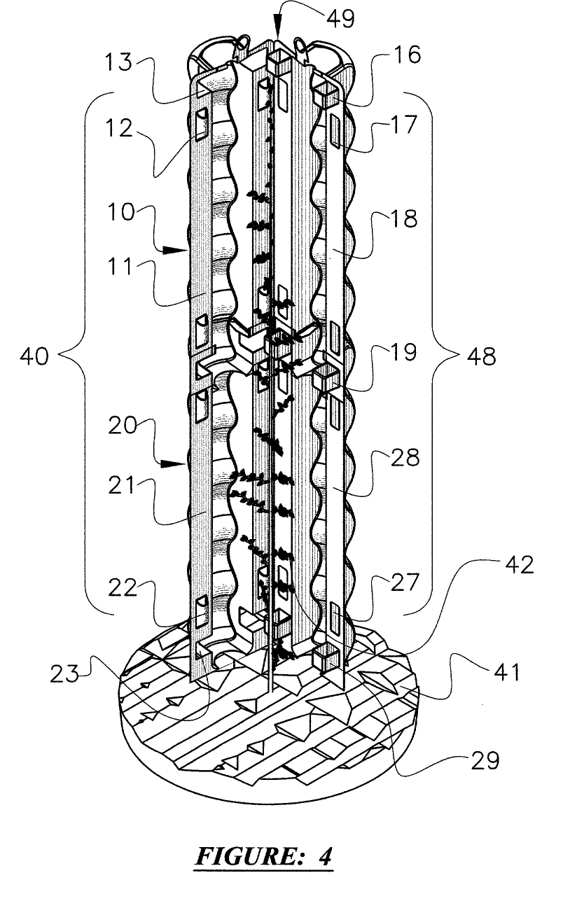

Reference is made to FIG. 4 which shows the combined unit being installed around a seedling 42. After the seedling 42 has been planted into the ground 41, the left wing 40 of the coupled protective cover 49 is closed around the seedling 42 making contact with the right wing 48 of the protective cover 49, thus forming a protected cavity about the seedling 42. The left spines 11 and 21, when folded to meet the right spines 18 and 28, create a strong and rigid structural member due to the combined double thickness of the material.

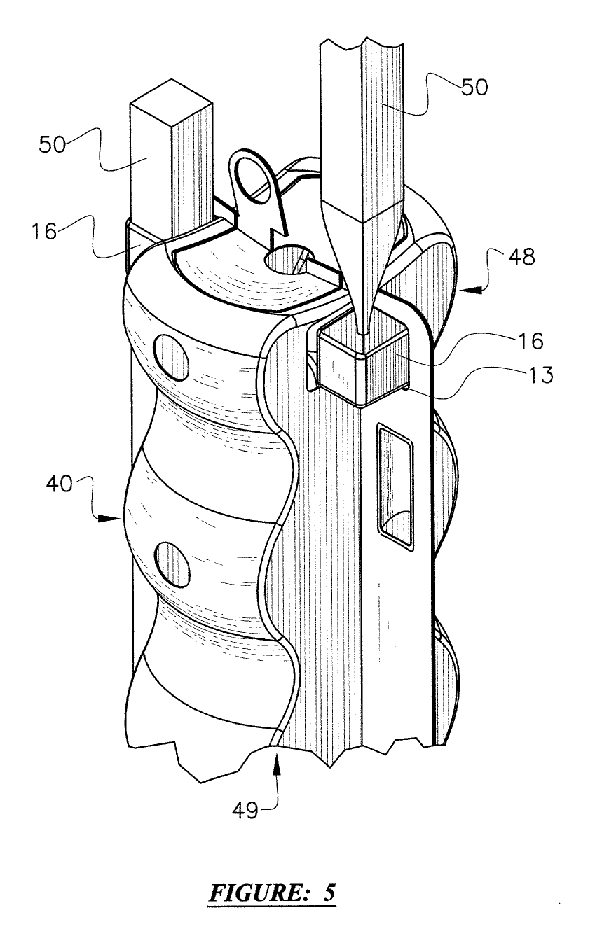

FIG. 5 illustrates the installation of wooden stakes 50. When the left wing 40 comes in contact with the right wing 48 of the protective cover 49, the rectangular locking straps 16, 19 and 29 pass through the rectangular holes 13 and 23. At this point, the wooden stakes 50 are passed through the linearly aligned rectangular locking straps 16, 19 and 29, creating a strong and superior locking mechanism to prevent the wings from opening up. The sharp end of the stakes may be driven into the ground. These stakes 50 therefore add to the rigidity and stability of the standing protective cover 49, making it difficult to bend or to be pushed over by strong winds or when animals brush up against the cover.

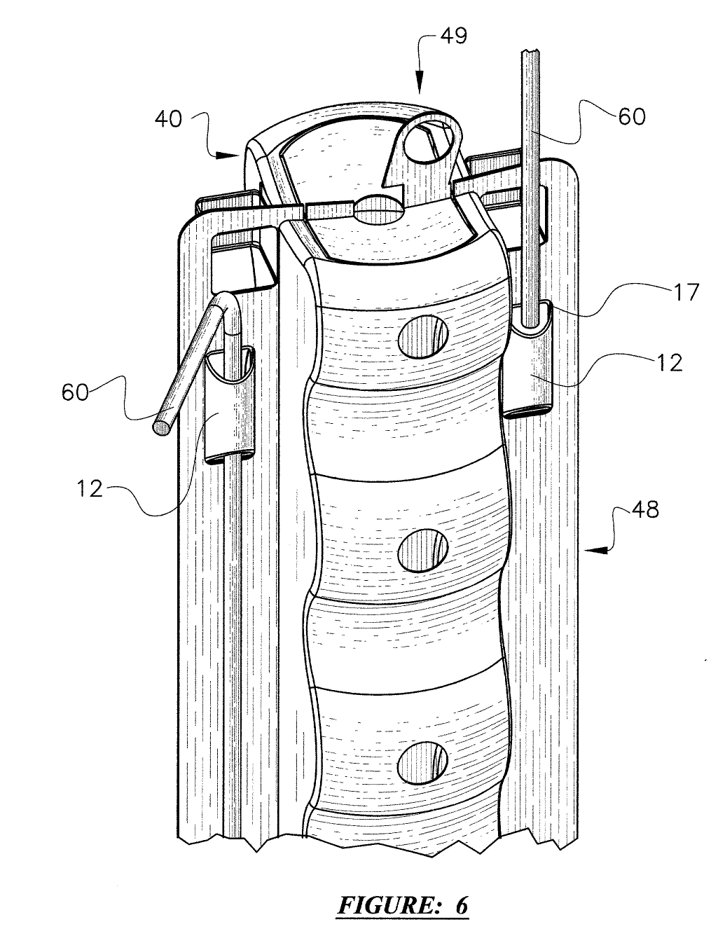

FIG. 6 shows the installation of the metal rods 60. When the left wing 40 comes in contact with the right wing 48 of the protective cover 49, the cylindrical shaped locking straps 12 and 22 pass through the rectangular holes 17 and 27, respectively. The metal rods 60 may therefore be passed through the linearly aligned locking straps 12 and 22, creating a strong and superior locking mechanism. The metal rods 60 add to the rigidity of the protective cover 49, making it difficult to bend when contacted by strong winds or when animals brush up against the cover. The rods may be used in conjunction with or independently of the wooden stakes

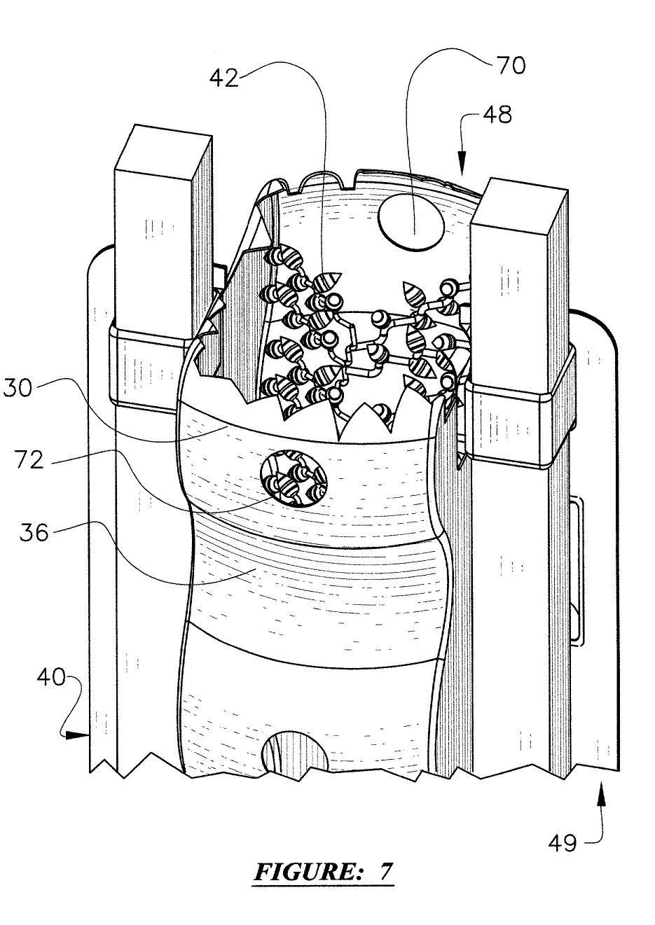

FIG. 7 illustrates ventilation of the protective cover 49 for seedlings and small trees. Geographic areas vary in temperature and humidity, and so for this reason it is anticipated that the number of ventilation holes 70 for the protective cover 49 will vary from zero to twelve holes per section 10, 20, namely a maximum of six holes 72 on the left side and a maximum of six holes 70 on the right side. The fewer the ventilating holes, the higher the condensation levels will be for self-watering. The maximum diameter portion 30 and the minimum diameter portion 36 of the shell-form 37 allow additional space for cross-ventilation between the two diameter portions. This helps to prevent the protective cover 49, when in the closed (i.e. joined or mated) position, from reaching temperatures that could damage the seedling or small tree, in geographic areas of high temperatures.

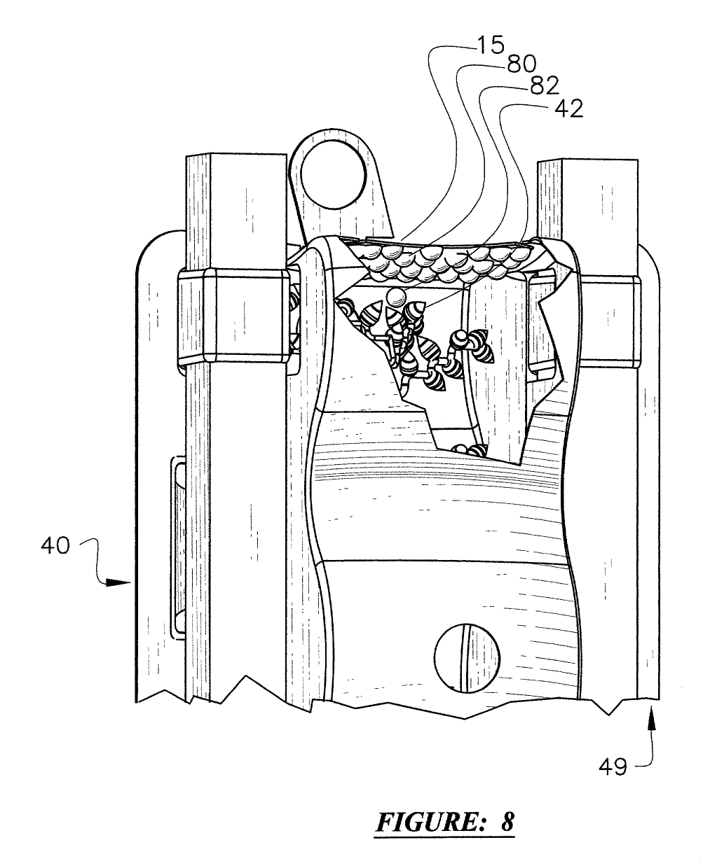

Reference is next made to FIG. 8 which revealing the self-watering mechanism technique for assisting in the watering of seedlings and small trees when using the protective cover 49. To illustrate, during the evening, the temperature outside the protective cover 49 is typically cool while the temperature on the inside of the protective cover 49 is typically still warm from the afternoon sun. This cooler outside temperature should cause the plastic of the protective cover to cool down, thus promoting water condensation on the inner cavity walls. It is an object and advantage of this invention to strategically collect such condensed water and to place it onto the enclosed seedling or small tree. The top cutout section of the left wing 40 shows the drops of condensation 80 that have formed on the bottom part of the roof portion 15, which has a spherical concave shape. This spherical concave shape urges these drops of water 80 to migrate by gravity to the center of the protective cover 49, allowing a steady follow of water 82 to drop onto the seedling or small tree 42.

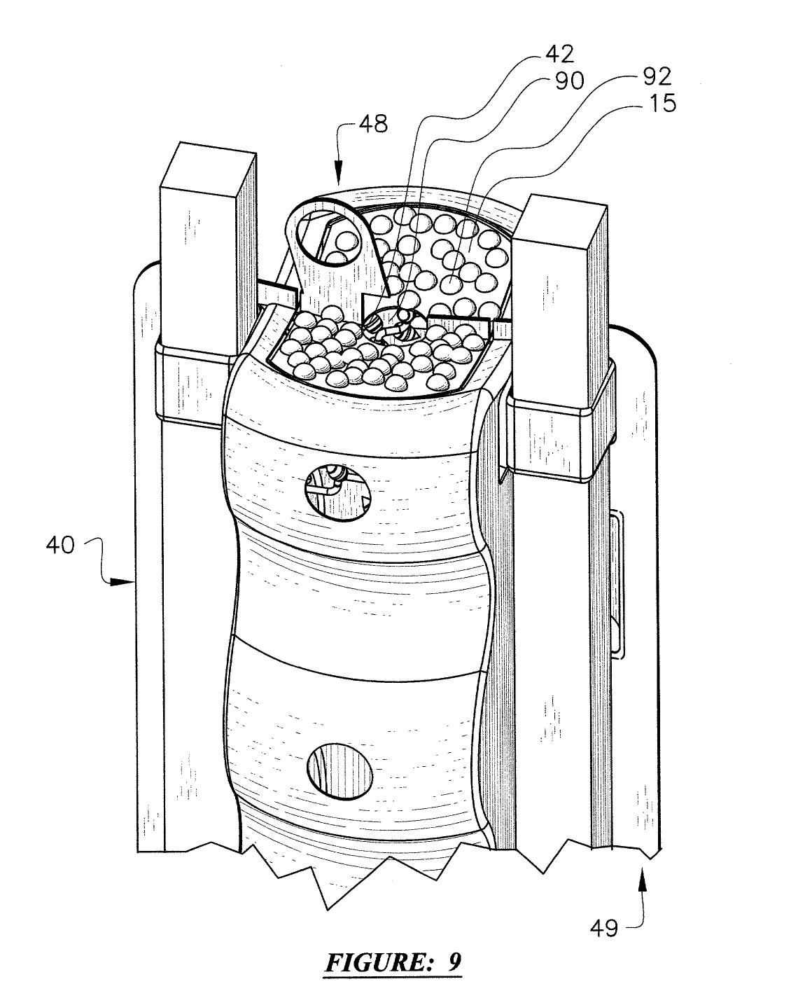

FIG. 9 illustrates the external watering feature of the protective cover 49. When the left wing 40 and the right wing 48 are locked in the closed position, rain drops 92 may collect on the outside top part of the roof portion 15, which has a spherical concave shape. The rain drops 92 are urged by gravity to drain into a hole 90 situated in the center of the spherical concave shape of the roof portion 15, thus watering the enclosed seedling or small tree 42.

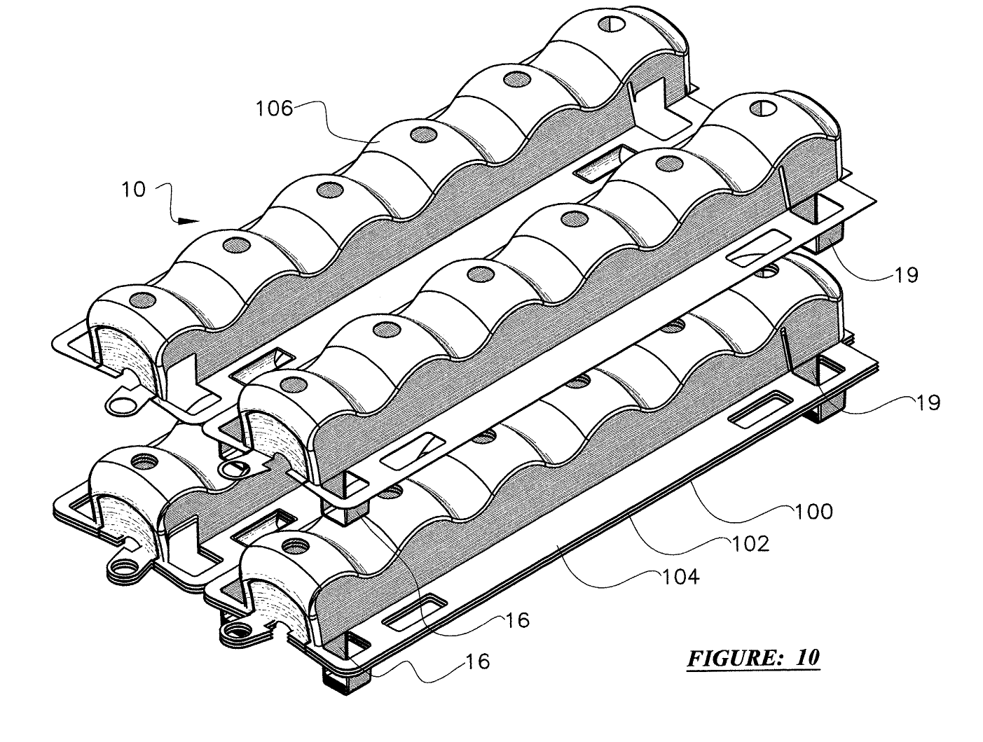

FIG. 10 demonstrates the stackability of the top covers 10. It will be understood that the bottom covers 20 are stacked in the same manner. The top cover 10 is stacked by placing the outer rectangular locking straps 16 and 19 of a first top cover (designated by 100), into the inner part of the rectangular locking straps 16 and 19 of a second top cover (designated by 102). This in turn is repeated for covers 104, 106 and so on. Such stackability results in a much higher ratio of plastic covers per cubic foot for shipping or storing purposes than what is presently available for tube shaped seedling and tree protector products.

Finally, FIG. 11 illustrates the protective properties of the cover 49 after installation, when animals are present. When the left wing 40 is in the closed position with the right wing 48 of the protective cover 49, secured to the ground 41 by the two wooden stakes 50, then any approaching animals 110 are unable to enter the secured area for the seedling or small tree, ensuring the plant's protection from unwanted contact.

It will be apparent to one skilled in the art that modifications may be made to the illustrated embodiment without departing from the spirit and scope of the invention as hereinafter defined in the Claims.

I claim:

1. A top and bottom protective cover for use in a singular fashion or snap locked together in a plural format, for seedlings or small trees, comprising:
a sheet of moulded pliable polymer material, capable of being folded in the center to create a living hinge;
dual channel-like shell-form bodies adjacent to each side of the living hinge, with a poly hour-glass shape, a pair of sidewalls and a bottom having a hole;
a top protective cover consisting of a roof for collecting water internally in the form of condensation and externally in the form of rain, dispersing this water directly onto the plant;
a bottom protective cover consisting of a roof that is open and has one male snap on each sidewall;
a spine perpendicular to each sidewall for adding strength and rigidity to the protective cover, when the cover is folded or in the closed position, wherein the spine further provides a support plane for a locking mechanism.

2. The protective cover for seedlings and small trees as defined in claim 1, wherein a locking mechanism that is built into this sheet of plastic, offering duality by the use of wooden stakes or metal rods.

3. The protective cover for seedlings and small trees as defined in claim 1, wherein an accessible tube like cavity can gain access to the seedling or small tree, without damaging the branches.

4. The protective cover for seedlings and small trees as defined in claim 1, wherein the cavity can create an environment that will allow self-watering by means of condensation on the inside of the roof, to be directed to the seedling or small tree.

5. The protective cover for seedlings and small trees as defined in claim 1, wherein a snap lock mechanism can join any number of extensions, varying the size from one top protective cover, to one top protective cover and any number of bottom protective covers.

6. The protective cover for seedlings and small trees as defined in claim 1, wherein the cavity with the poly hour-glass shape offers a maximum diameter and a minimum diameter allowing more space between the cavity walls and the plant for better ventilation with the necessary holes that would be provided.

7. The protective cover for seedlings and small trees as defined in claim 1, wherein the protective cover for seedlings and small trees can have a much higher stacking ratio over the existing tube like protectors.

8. The protective cover for seedlings and small trees as defined in claim 1, wherein the cavity is not accessible to small rodents at the bottom of the protective cover.

9. The protective cover for seedlings and small trees as defined in claim 1, wherein the manufacturablity of the protective cover for seedlings or small trees, has been greatly improved with all post production being eliminated by incorporating these features on one piece of plastic.

10. The protective cover for seedlings and small trees as defined in claim 1, wherein the roof has a spherical concave shape and a circular perforated section that can be removed by pulling on the tab and allowing for an optional open cavity.
